(19) United States
(12) Patent Application Publication
(10) Pub. No.: US 2025/0129632 A1
(43) Pub. Date: Apr. 24, 2025

(54) CODED COMBINATION LOCK

(71) Applicant: RIMOWA GmbH, Köln (DE)

(72) Inventors: Peter Schulte, Overath (DE); Julian Neukirchen, Köln (DE); Ralf Juck, Wuppertal (DE)

(21) Appl. No.: 18/908,968

(22) Filed: Oct. 8, 2024

(30) Foreign Application Priority Data
Oct. 23, 2023 (DE) 10 2023 129 098.3

(51) Int. Cl. E05B 37/00; E05B 37/02

(52) U.S. Cl. CPC E05B 37/0065; E05B 37/02

(57) ABSTRACT

A combination lock which, by means of a locking mechanism, can be transferred from a blockage position into an opening position. By means of at least three rotationally adjustable bearing sleeves, the locking mechanism is, by at least one bearing sleeve in a blocking setting of the bearing sleeve, blocked by a blocking device of the bearing sleeve so as to be prevented from being transferred from the blockage position into the opening position. By virtue of all of the bearing sleeves being arranged in a release setting, the locking mechanism is movable from the blockage position into the opening position. On each bearing sleeve, there is arranged a coding wheel which projects partially into an aperture in a front cover through which a checking setting of each of the bearing sleeves can be detected on the basis of a coding. The combination lock may be incorporated into a suitcase.

### CROSS REFERENCE TO RELATED APPLICATIONS

This application claims the benefit of priority under 35 U.S.C. § 119 to German Patent Application No.: 10 2023 129 098.3, filed Oct. 23, 2023, the content of which is incorporated herein by reference in its entirety.

### FIELD

The invention relates to a combination lock, in particular a suitcase lock. The invention furthermore relates to a suitcase, in particular for luggage, wherein the suitcase has a receiving space which can be closed by means of such a combination lock.

### BACKGROUND

The statements in this section merely provide background information related to the present disclosure and several definitions for terms used in the present disclosure and may not constitute prior art.

Combination locks of various types of construction are known in which the coding wheels are arranged in planar fashion in one plane, or coaxially with respect to one another on a common shaft. In general, to open the combination lock, the locking mechanism must be unlocked, wherein, for unlocking, all of the coding wheels must be situated in their respective release settings. In order that a user can retrieve the combination of the release settings of all of the coding wheels, detectable key characters are formed on a lateral surface of the coding wheels. A key code specifies the combination of the key characters in a particular sequence in which all of the coding wheels, or the respective bearing sleeves, are situated in their respective release settings.

Since it may occur that the key code is lost and/or forgotten, it is desirable for the combination lock to provide a means by which the key code can be ascertained. Here, it has proven to be very difficult, and/or generally not possible without destroying the closed article, to uninstall the combination lock in order to analyze the locking mechanism relative to the settings of the bearing sleeves.

DE 2261 029 A1 has disclosed a combination lock in the form of a buckle-type combination lock such as is used on suitcases and luggage articles. Here, the coding wheels are arranged coaxially with respect to one another, by means of bearing sleeves, on a common shaft. Furthermore, in the case of this buckle combination lock, the key code can be personalized by a user by virtue of a rotational offset between the coding wheels and the associated bearing sleeve being individually adjustable. This has the result that the key code is increasingly also adjusted inadvertently. In order that the lock can nevertheless be unlocked in such a situation where the key code is not known, visually or haptically perceptible codings are formed on the bearing sleeves. When the bearing sleeves have been transferred into a checking setting, said codings can be identified from the outside on the basis of openings and indentations.

In particular, it is known that the codings are arranged at a fixedly defined coding angle relative to the blocking device of the bearing sleeves, said coding angle being the same for all bearing sleeves but known only to an authorized person.

By virtue of the codings being detected from the outside in the checking setting and all of the coding wheels subsequently being rotated, if necessary, through the fixedly defined coding angle, the bearing sleeves are transferred into their respective release settings without the user having knowledge of the key code. Here, the codings are formed at the same location on all of the bearing sleeves. In particular, in this case, the checking setting of the bearing sleeves may simultaneously also be the release setting of the bearing sleeves, such that the coding angle is 0°. To open the buckle combination lock, it is sufficient in this case for all of the bearing sleeves to be arranged such that the codings on the respective bearing sleeves are situated in a row.

A problem in the case of the solution known from DE 2261 029 A1 for ascertaining the key code is that, by means of the coding, it is made possible for even unauthorized persons to open the combination lock, unnoticed, within a very short time if they can identify the coding and know the coding angle. If they do not know the fixedly defined coding angle, they can find this out relatively quickly, because it is the same for all coding wheels. This makes it possible, for example if control over the suitcase is briefly obtained, for unauthorized suitcase contents to be exchanged or added. It is therefore desired that unauthorized persons cannot open the combination lock unnoticed, or require a greater amount of time to do so.

In both castors of the conventional art as described above, the castor housing surrounds the wheels in a fork-like manner and, in this regard, conceals the design of the wheels, which is undesirable.

### SUMMARY

An objective of the present disclosure is to provide a combination lock, and a suitcase having said combination lock, which overcome the disadvantages known from the prior art, in that the combination lock makes unnoticed opening of the combination lock without knowledge of the key code more difficult, and at the same time makes it relatively easily for the key code to be ascertained by an authorized person.

According to one aspect of the present disclosure, the objective is achieved by a combination lock, in particular a suitcase lock, comprising a locking mechanism through which the combination lock can be transferred from a blockage position into an opening position, the locking mechanism including at least three rotationally adjustable bearing sleeves. The locking mechanism is, by at least one bearing sleeve being in a blocking setting of the bearing sleeve, blocked by a blocking device of the bearing sleeve so as to be prevented from being transferred from the blockage position into the opening position, and, by virtue of all of the bearing sleeves being arranged in a release setting of each bearing sleeve, said locking mechanism is released for a movement from the blockage position into the opening position. On each bearing sleeve, there is arranged a coding wheel which projects partially into an aperture in a front cover, such that a checking setting of each of the bearing sleeves can be detected through the aperture on the basis of a coding, which is perceptible from the outside, of the bearing sleeve, and the release setting of the bearing sleeve can be set by virtue of the bearing sleeve being rotated through a coding angle of the particular bearing sleeve proceeding from the checking setting of the bearing sleeve. The coding angles of at least two bearing sleeves differ, and the bearing sleeves have a second coding which is formed as a key marking such that the coding angle of the particular bearing sleeve is fixedly assigned to the form of the key marking and can thus be determined, and the second coding, formed as a key marking, is formed as an all-over coloration of the bearing sleeve or of the material of the bearing sleeve or is haptically perceptible by means of a checking tool.

According to another aspect of the present disclosure, the objective is achieved by a suitcase, in particular for luggage, having a receiving space which can be closed by means of a combination lock as described above and further defined herein.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is an exploded view of an assembly of a locking mechanism;

FIG. 2 is a side view of the assembly of the locking mechanism according to FIG. 1 in the viewing direction A according to FIG. 1;

FIG. 3 is a side view of the assembly of the locking mechanism according to FIG. 1 in the viewing direction B according to FIG. 1;

FIG. 4 is a perspective illustration of a bearing sleeve of the assembly of the locking mechanism according to FIG. 1 having a first embodiment of a blocking device;

FIGS. 5 to 14 are plan views of exemplary variants of the bearing sleeve having a blocking device according to FIG. 4, each having a different offset for the coding;

FIG. 15 is a plan view of the assembly of the locking mechanism in a blockage position, wherein the bearing sleeve is in a blockage setting and in a checking setting;

FIG. 16 is a sectional view of the assembly of the locking mechanism according to FIG. 15 along the section line C-C;

FIG. 17 is a plan view of the assembly of the locking mechanism in a blockage position, wherein the bearing sleeve is in a release setting;

FIG. 18 is a sectional view of the assembly of the locking mechanism according to FIG. 17 along the section line D-D;

FIG. 19 is a plan view of the assembly of the locking mechanism in an opening position, wherein the bearing sleeve is in the release setting;

FIG. 20 is a sectional view of the assembly of the locking mechanism according to FIG. 19 along the section line E-E; and

FIG. 21 is a plan view of a further embodiment of the bearing sleeve having a further variant of the blocking device.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally provides a combination lock, in particular a suitcase lock. The combination lock has a locking mechanism by means of which the combination lock can be transferred from a blockage position into an opening position. The locking mechanism has at least three rotationally adjustable bearing sleeves. The locking mechanism is, by at least one bearing sleeve in a blocking setting of the bearing sleeve, blocked by a blocking device of the bearing sleeve so as to be prevented from being transferred from the blockage position into the opening position. Furthermore, by virtue of all of the bearing sleeves being arranged in a release setting of each bearing sleeve, said locking mechanism is released for a movement from the blockage position into the opening position. Also, on each bearing sleeve, there is arranged a coding wheel which projects partially into an aperture in a front cover. Here, a checking setting of each of the bearing sleeves can be detected through the aperture on the basis of a coding, which is perceptible from the outside, of the bearing sleeve. The release setting of the bearing sleeve can be set by virtue of the bearing sleeve being rotated through a coding angle of the particular bearing sleeve proceeding from the checking setting of the bearing sleeve.

By virtue of the fact that the coding angles of at least two bearing sleeves differ, and the bearing sleeves have a second coding which is formed as a key marking such that the coding angle of the particular bearing sleeve is fixedly assigned to the form of the key marking and can thus be determined, and the second coding, formed as a key marking, is formed as an all-over coloration of the bearing sleeve or of the material of the bearing sleeve or is haptically perceptible by means of a checking tool, it is achieved that, to transfer the locking mechanism into its opening position, it is not sufficient for the bearing sleeves to be rotated such that the codings are arranged in a row, or for all of the coding wheels to additionally be rotated through an identical coding angle. Unlocking of the locking mechanism, or opening of the combination lock, is therefore possible unnoticed only if the coding angle of each individual coding wheel is known.

This furthermore has the advantage that the user, for example a service technician at the suitcase manufacturer, to whom all of the assignments of the specific key markings to the specific coding angles are known, is provided with all of the information that they require to rotate the bearing sleeve into the release setting, and thus to open the combination lock without knowledge of the key code, by each bearing sleeve or by the first and second coding arranged on the bearing sleeve. Using the first coding, the user can detect the checking setting of the bearing sleeves, wherein the second coding discloses to the user the coding angle through which the user must rotate each bearing sleeve in order to transfer it into its release setting.

Thus, in the context of the present disclosure, the combination lock is unlocked, without knowledge of the key code, by virtue of a user detecting the first coding on each bearing sleeve and thus bringing the bearing sleeves into their respective checking settings. Proceeding from this checking setting, the user then needs to rotate the bearing sleeves through the respective coding angles, wherein the coding angles for at least two bearing sleeves differ from one another, and then arrives at the release setting of the bearing sleeve. Since the coding angles of at least two bearing sleeves differ, the locking mechanism cannot be transferred into its opening position simply by lining up the codings or transferring all of the bearing sleeves into their respective checking settings.

Under the prerequisites according to one aspect of the present disclosure, the coding angle of at most two bearing sleeves may also be 0°, such that, for two bearing sleeves, the checking setting also simultaneously corresponds to the release setting. Since, in the context according to the present disclosure, in this case at least one of the three bearing sleeves has a differentiated coding angle, the locking mechanism cannot be transferred into its opening position without knowledge of the at least one different coding angle.

In particular, the bearing sleeves having different coding angles are selected for a particular combination lock at random or on the basis of predetermined sequences of bearing sleeves having different coding angles, such that, without knowledge of the specifically selected bearing sleeves, it is not possible to predict the coding angles of the bearing sleeves of a particular combination lock.

Information regarding the coding angles of the bearing sleeves of a particular combination lock may expediently be stored in the form of a security card attached to the combination lock or to the suitcase, or may be stored in a database at the manufacturer. The coding angles are preferably paired with the serial number of the particular combination lock or with a serial number of a suitcase in which the combination lock is installed, such that, based on the serial number, the associated coding angles of the bearing sleeves can be retrieved from a database, in particular at the manufacturer.

In one possible embodiment, the combination lock and/or the suitcase is labeled with an alphanumeric code that can be read from the outside, in particular by way of an adhesive label, or that can be read out, wherein the alphanumeric code characterizes the coding angles of the bearing sleeves of the combination lock in an encrypted form transformed using a cryptographic method, preferably in combination with a unique serial number of the combination lock.

Preferably, the coding angles of a combination lock, in particular the alphanumeric code, are/is stored in an RFID tag and can be read out by means of a corresponding RFID reader. This RFID tag may be formed on the combination lock itself or on the suitcase in which the particular combination lock is installed.

In one advantageous variant of the combination lock, the codings formed on the bearing sleeves are each perceptible from the outside through a checking gap in an edge region of the particular coding wheel. The checking gap is particularly advantageously formed between the particular coding wheel and a wall, adjacent to the coding wheel, of the particular aperture, or an adjacently arranged further coding wheel. This embodiment has the advantage that a user has easy access to the codings on the bearing sleeves. The checking gap may expediently be formed such that the user can visually identify the coding through the checking gap. The checking gap may also be formed such that a checking tool can be inserted into the particular checking gap and engaged with the bearing sleeve or with the coding.

One specific embodiment of the combination lock provides for at least one of the codings to be in the form of a visually identifiable coding. One expedient visual marking is for example a colored labeling. Expediently, a color for the first coding may indicate the checking setting, and a further color or a color collection as a key marking may indicate the particular coding angle. By way of example, such an embodiment could be implemented such that, for example, the color yellow represents the checking setting and the colors green, blue, red and white each indicate a coding angle, for example 90°, 180°, 270° and 360° or 0°. The coding angles advantageously correspond to an angle from the group of angles in steps of 360°/number of key characters on the coding wheel; in general, ten key characters are arranged on a coding wheel, that is to say 0°, 36°, 72°, 108°, 144°, 180°, 216°, 252°, 288° and 324°. It may also be the case that simply the position of the second coding on the bearing sleeve constitutes the first coding. For example, in the embodiment, a blue dot could be formed on the bearing sleeve. The position of this blue dot indicates in particular the checking setting, wherein the color blue signals a coding angle of, for example, 180°. Expediently, each bearing sleeve may provide the second coding, formed as a key marking, by virtue of said bearing sleeve, or the material of the bearing sleeve, being completely colored.

Alternatively or in addition to the colored labeling as a first and/or second coding, one advantageous embodiment provides for at least one the codings to be haptically perceptible by means of a checking tool. Expediently, the haptically perceptible coding is formed as a notch formed in the bearing sleeve. The notch may in this case also be a slot extending all the way through the bearing sleeve, or may be an indentation or groove formed in the bearing sleeve. The haptically perceptible coding is advantageously formed as a radially outwardly pointing bulge or elevation.

In particular, the checking setting can be ascertained by means of the checking tool, wherein a colored labeling as a key marking indicates the checking angle. This division into a haptically perceptible first coding and a visually perceptible second coding is particularly advantageous in an embodiment in which the first and the second coding are arranged or formed at the same location on the bearing sleeve. In this way, the checking setting can be easily detected by means of the checking tool, whereupon a look, in particular through the checking gap, is sufficient to identify the second coding and thus the coding angle, without the need to search the bearing sleeve.

A checking tool can represent anything that is suitable for providing haptic or visual feedback to the user. In particular, the combination lock may have guide means for guiding the checking tool. The guide means may limit the maximum size of the checking tool, such that unauthorized persons who do not have an intended checking tool are limited in terms of their selection of an alternative means for substituting the checking tool. Furthermore, the guide means have the advantage that the checking tool does not become jammed as it is inserted into the interior of the combination lock, and is guided, “blind”, directly to the bearing sleeve such that the coding can be easily detected.

The checking tool may for example also be formed as an optical tool which illuminates the gap and at the same time identifies the wavelength of the light reflected by the bearing sleeve, and thus the color of the coding.

In a preferred embodiment, the first coding is provided by means of a position of the haptically perceptible coding on the bearing sleeve. The position of the haptically perceptible coding may in this case expediently indicate the checking setting of the bearing sleeve. Alternatively or in addition, the second coding, formed as a key marking, is provided by means of a form of the haptically perceptible coding. The form may be such that the coding angle can be determined from the form of the haptically perceptible coding. Expediently, in this embodiment, the checking tool may be designed as checking gage. Preferably, a second coding formed as a notch and formed at least as a key marking may for example have a width which is determinable by means of the checking tool, wherein the width indicates the coding angle. It has proven to be expedient here that a set of checking tools designed as checking gages allows the user to exactly determine the particular coding angle. The notches may expediently have a width of 1 mm, 1.5 mm or 2 mm, wherein these represent, by way of example, the coding angles 120°, 240° and 360° or 0°. Accordingly, the user having three checking tools correspondingly designed as checking gages can use the checking tools to measure each of the notches to be checked, and can thus determine the width of the notch and the coding angle of the bearing sleeve.

In practice, it is expedient if the locking mechanism has an actuating shaft. Here, in particular, bearing sleeves having the coding wheels are arranged on the actuating shaft so as to be mutually independently rotatable and so as to be coaxial with respect to one another. In particular, by means of this design, the combination lock and the locking mechanism can be implemented in compact form and with few components.

In particular, when all of the bearing sleeves are in the release setting, the actuating shaft is movable axially into a release position, in which the locking mechanism is in the opening position and unlocked. It is furthermore expediently the case that, when at least one bearing sleeve is in the blocking setting, the actuating shaft is blocked in a locking position by means of the blocking device. Here, the actuating shaft is preferably formed such that, in the locking position, the locking mechanism is locked in the blockage position, such that the combination lock cannot be opened.

Advantageously, in one particular embodiment, the bearing sleeves having the coding wheels are arranged in planar fashion with respect to one another, and so as to be mutually independently rotatable, on respectively dedicated actuating shafts. Expediently, for this purpose, the respective actuating shafts run parallel to one another and are offset with respect to one another.

To increase the user-friendliness of the combination lock, it is made possible for the user to change the key code. Expediently, for this purpose, a particular embodiment of the combination lock is provided in which, in particular when the bearing sleeves are in the release setting, the coding wheels are movable relative to the respective bearing sleeves axially between a normal setting, in which the coding wheel is fastened rotationally conjointly to the bearing sleeve, and a configuration setting. Here, the coding wheels are expediently movable relative to the respective bearing sleeves such that, in the configuration setting, the coding wheel is freely rotatable relative to the associated bearing sleeve and can be re-installed into the normal setting with an angular offset on the bearing sleeve. It is thus possible, for example, for the coding wheel to be brought into a freely rotating arrangement with respect to the bearing sleeve. In the freely rotating arrangement, the user can rotate the particular coding wheel until it has reached a desired position. Once the particular coding wheel is situated in the desired position, the coding wheel can be transferred into the rotationally conjoint arrangement with respect to the bearing sleeve. Here, the bearing sleeve is advantageously in its release setting, such that the user can open the combination lock by moving the coding wheels into the set position.

In order that the user can identify the position of the coding wheels, key characters are arranged on the lateral surface of the coding wheels.

The key characters on the coding wheels, which key characters are to be brought into a particular arrangement in order to unlock the combination lock, form the key code. The key characters may in this case takes the form of visual, haptic or acoustic features. In particular, the key characters are alphabetic characters, numerical characters, figures, symbols or a combination of these features. Also, each coding wheel may have key characters of different form to those of the other coding wheels, such that the key code consists of a combination of numerical characters, alphabetic characters, figures etc.

Further advantageous embodiments of the present disclosure will emerge from the following description of the figures.

In the various figures of the drawing, identical parts are always denoted by the same reference signs.

With regard to the description that follows, the present disclosure is not limited to the exemplary embodiments and is not limited to all or multiple features of described combinations of features; rather, each individual sub-feature of the/each exemplary embodiment, even considered separately from all other sub-features described in connection therewith, is of significance on its own, and in combination with any features of another exemplary embodiment, for the subject matter of the present disclosure.

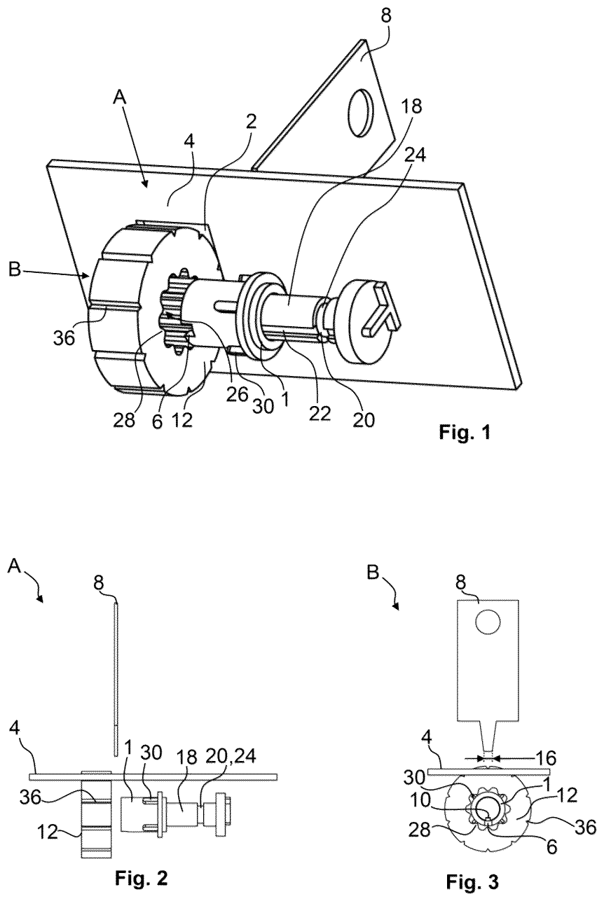

FIGS. 1 to 3 and 15 to 20 illustrate an assembly of a combination lock. This is in particular an assembly of a combination lock designed/used as a suitcase lock.

The combination lock has a locking mechanism that is illustrated in part in FIGS. 1 to 3 and 15 to 20. By means of the locking mechanism, the combination lock can be transferred from a blockage position into an opening position.

The locking mechanism of the combination lock comprises at least three rotationally adjustable bearing sleeves 1. FIGS. 1 to 3 and 15 to 20 illustrate only one adjustable bearing sleeve 1; the embodiment illustrated is transferable to all three bearing sleeves 1 that are provided.

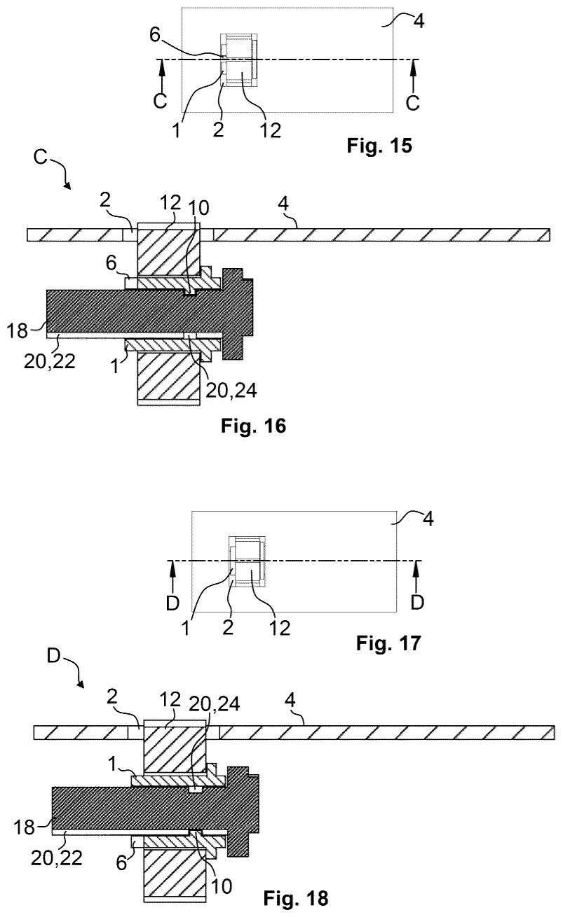

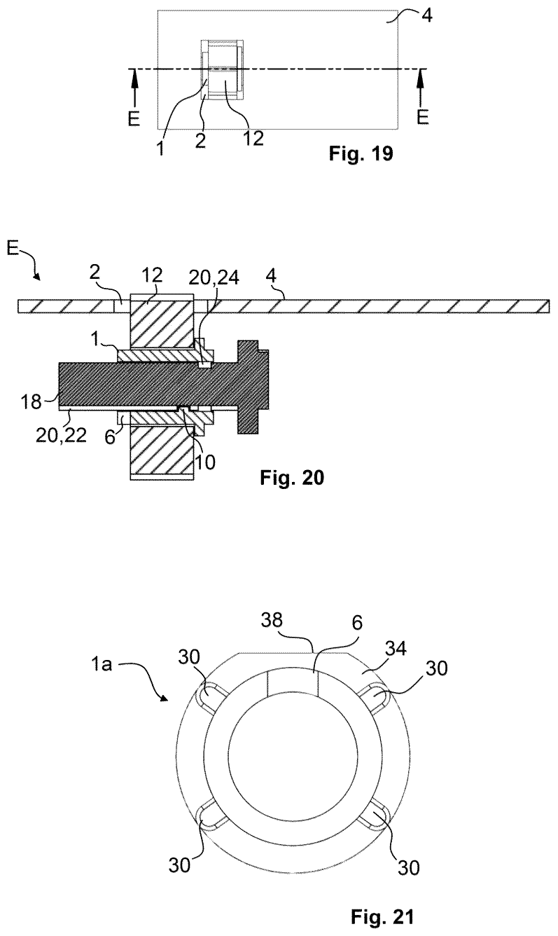

The bearing sleeves 1 each have a blocking setting, illustrated by way of example in FIGS. 15 and 16, and a release setting, illustrated by way of example in FIGS. 17 to 20. Here, if at least one bearing sleeve 1 is in the blocking setting of the bearing sleeve 1, the locking mechanism is blocked by a blocking device 10 of the bearing sleeve 1 so as to be prevented from being transferred from the blockage position, illustrated in FIGS. 15 to 18, into the opening position, illustrated in FIGS. 19 and 20. Furthermore, by virtue of all of the bearing sleeves 1 being arranged in the release setting of each bearing sleeve 1, the locking mechanism is released for a movement from the blockage position into the opening position.

As per the illustrations of the single bearing sleeves 1 in FIGS. 1 to 3 and 15 to 20, on each bearing sleeve 1, there is arranged a coding wheel 12 that projects partially into an aperture 2 in a front cover. FIG. 1 shows the perspective from a region in the interior of the locking mechanism, such that the view is directed through the aperture 2 toward the outside, into a region outside the locking mechanism. In particular, the region outside is accessible to users, such that the user can act on, in particular rotationally adjust, each coding wheel 12 that projects through the aperture 2.

In one preferred embodiment, the locking mechanism has an actuating shaft 18, as illustrated in FIGS. 1 to 3 and 15 to 20. Expediently, the bearing sleeves 1 having the coding wheels 12 may be arranged on the actuating shaft 18 so as to be mutually independently rotatable and so as to be coaxial with respect to one another. It has proven to be advantageous here for the actuating shaft to preferably be designed such that, when all of the bearing sleeves 1 are in the release setting, as illustrated in FIGS. 17 to 20, the actuating shaft 18 is movable axially into a release position, in which the locking mechanism is unlocked and in the opening position, and when at least one bearing sleeve 1 is in the blocking setting, as illustrated in FIGS. 15 and 16, said actuating shaft is blocked, by means of the blocking device 10, in a locking position in which the locking mechanism is locked in the blockage position. By way of example, FIG. 1 illustrates an advantageous variant of this embodiment based on a bearing sleeve 1 arranged on the actuating shaft 18.

In the exemplary embodiment illustrated in FIGS. 16, 18 and 20, a radially inwardly protruding lug as a blocking device 10 advantageously engages into a groove 20 formed, correspondingly with respect to the lug, on an outer shell of the actuating shaft 18. The groove 20 preferably has a release portion 22, which runs axially with respect to the actuating shaft, and a blocking portion 24, which intersects the release portion 22 and encircles the actuating shaft 18.

In particular, when the lug is arranged in the blocking portion 24, as illustrated in FIG. 16, the bearing sleeve 1 is rotatable relative to the actuating shaft 18. For as long as the lug is not arranged in the region of the intersection between the release portion 22 and the blocking portion 24, the bearing sleeve 1 is expediently in its blocking setting, and the locking mechanism is blocked so as to be prevented from moving from the blockage position into the opening position. In particular, an axial movement of the actuating shaft 18 relative to the bearing sleeves 1 is blocked.

It is advantageously the case that, when the bearing sleeve 1 is rotationally adjusted relative to the actuating shaft 18 such that the lug is arranged in the region of the intersection between the release portion 22 and the blocking portion 24, as illustrated in FIG. 18, the particular bearing sleeve 1 is in its release setting. The bearing sleeve 1 can expediently be transferred into the axially running release portion 22, as illustrated in FIG. 20, if all of the bearing sleeves 1 of the locking mechanism with their respective lugs have also been arranged in their respective release settings, analogously to the aforementioned bearing sleeve 1, or in particular if said bearing sleeves have been arranged with their respective lugs in the region of the intersection between the release portion 22 and the blocking portion 24. Expediently, in this state, with all of the bearing sleeves 1 in their release settings, the locking mechanism can be transferred from the blockage position into the opening position.

It has proven to be advantageous if the blocking device 10 of the bearing sleeve 1 blocks the bearing sleeve 1, in the axially running release portion 22 outside the intersection between the release portion 22 and the blocking portion 24, against a rotation about the actuating shaft 18. An undesired adjustment of the locking mechanism is thus expediently prevented.

In an alternative assembly of the locking mechanism, the bearing sleeves 1, 1a having the coding wheels 12 are arranged in planar fashion with respect to one another, and so as to be mutually independently rotatable, on respectively dedicated actuating shafts. Expediently, for this purpose, the respective actuating shafts run parallel to one another and are offset with respect to one another.

The bearing sleeves 1 each have a checking setting, as illustrated in FIGS. 15 and 16. In particular, in the exemplary embodiment in FIGS. 15 and 16, the bearing sleeve 1 is situated both in the checking setting and simultaneously in the blocking setting. The checking setting of each of the bearing sleeves 1 can be detected through the aperture 2 in the front cover 4 on the basis of a coding 6, which is perceptible from the outside, of the bearing sleeve 1. FIGS. 1 to 3 illustrate a particular embodiment of the coding 6 in which the coding 6 is formed as a notch formed in the bearing sleeve 1, which notch can be detected by means of a checking tool 8 illustrated in FIGS. 1 to 3.

According to another aspect of the present disclosure, the release setting of the bearing sleeve 1 can be set by virtue of the bearing sleeve 1 being rotated through a coding angle of the particular bearing sleeve 1 proceeding from the checking setting of the bearing sleeve 1. FIGS. 5 to 14 illustrate different embodiments of bearing sleeves 1 according to the present disclosure, which provide different coding angles than the assembly illustrated in FIG. 1. According to the present disclosure, it is furthermore the case that the coding angles of at least two bearing sleeves 1 differ.

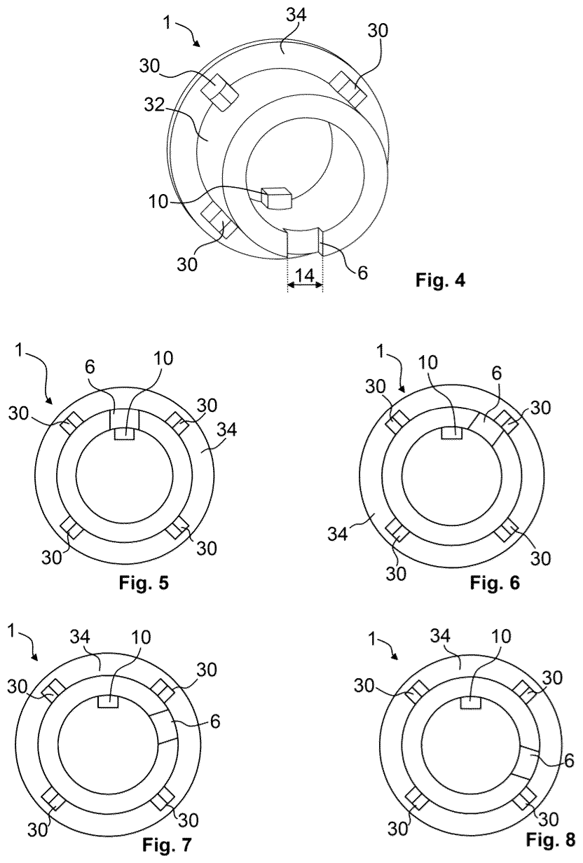

By way of example, in the exemplary embodiment of the assembly in FIG. 1, a bearing sleeve 1 is illustrated which corresponds to the variant of the bearing sleeve 1 illustrated in FIGS. 4 and 5 to 14. In particular, the coding angle is determined by the position and design of the blocking device 10 and the arrangement of the coding 6 of the bearing sleeve 1. Accordingly, the design variants of the bearing sleeve 1 illustrated in FIGS. 5 to 14 advantageously each have a different coding angle owing to their respectively different arrangements of the coding 6 relative to the blocking device 10.

The codings 6 formed on the bearing sleeves 1 are expediently each perceptible from the outside through a checking gap in an edge region of the particular coding wheel 12. In the exemplary embodiments illustrated in FIGS. 15, 17 and 19, the checking gap is advantageously formed between the coding wheel 12 and an edge region of the aperture 2. In an exemplary embodiment that is not illustrated, the checking gap is expediently formed between two adjacent coding wheels 12. It has proven to be advantageous if the aperture 2 has separating ribs such that each coding wheel 12 projects into a dedicated partitioned-off region of the aperture such in each case one separating rib is formed between the coding wheels 12.

In a further advantageous embodiment, the bearing sleeves 1 each have a second coding 6. In particular, the second coding 6 is formed as a key marking such that the coding angle of the particular bearing sleeve 1 can be determined from the form of the key marking.

An advantageous variant of the present disclosure provides for at least one of the codings 6 to be haptically perceptible by means of a checking tool 8. In particular, this variant is illustrated in FIGS. 1 to 3 and 15 to 20. The coding 6 is advantageously formed as a notch formed in the bearing sleeve 1. Correspondingly to the exemplary embodiment illustrated in FIGS. 1 to 3, said notch can be sensed by means of a checking tool 8 that can be inserted from the outside, in particular through the checking gap that is expediently formed between the edge region of the aperture and the coding wheel 12. Accordingly, the checking tool 8 can expediently be inserted through the aperture 2 into the region of the bearing sleeve 1. The user can preferably bring the coding 6 of the bearing sleeve 1 into operative connection with the checking tool 8 by rotationally adjusting the bearing sleeve 1. The contact of the coding 6 with the checking tool 8 expediently results in a haptic and preferably also an acoustic signal, which signals to the user that the bearing sleeve 1 has reached its checking setting.

One particular embodiment of the combination lock furthermore provides for the haptically perceptible coding 6 on the bearing sleeve 1 to be a coding 6 formed as a key marking. The haptically perceptible coding 6 is expediently formed such that the second coding 6, formed as a key marking, is provided by means of a form of the haptically perceptible coding 6, wherein the form is dependent on the coding angle, and such that the particular coding angle can be determined from the form of the coding 6.

By way of example, the haptically perceptible coding 6 may be formed as a notch, as illustrated in FIGS. 1 to 14, 15, 16, 18, 20 and 21. From the form, the coding angle can expediently be determined in accordance with the key marking, in that the width 14 of the notch indicates the particular coding angle. The width 14 of the notch is labeled in particular in FIG. 4. Expediently, to determine the width 14 of the notch or to check the coding angle, the checking tool 8 is designed as a checking gage. A checking tool 8 designed as a checking gage is illustrated by way of example in FIG. 3. It is expedient that, to determine the width 14 of the notch or the particular coding angle, use may be made of a set of checking tools 8 designed as checking gages, wherein each checking gage is designed to correspond to a particular width 14 of the notch. In the exemplary embodiment illustrated in FIG. 3, the checking gage has a width 16 which corresponds to the width 14 of the coding 6 formed as a notch. In particular, the user can detect a coding angle from accurately fitting correspondence of the respective widths 14, 16; by way of example, said coding angle is 180° in the exemplary embodiment illustrated in FIGS. 1 to 3.

In particular, FIGS. 1 to 3 illustrate a particular embodiment in which the haptically perceptible coding 6 of the bearing sleeve 1 provides both a first coding 6, for detecting the checking setting of the bearing sleeve 1, and a second coding 6, formed as a key marking, for determining the coding angle. Advantageously, the first coding 6, by means of which the checking setting of the bearing sleeve 1 can be detected, is provided by means of a position of the haptically perceptible coding 6 on the bearing sleeve 1, and at the same time, the second coding 6, which is formed as a key marking and by means of which the coding angle can be determined, is provided by means of a form of the haptically perceptible coding 6, in the exemplary embodiment illustrated in FIGS. 1 to 3 by means of the width 14 of the notch.

A further embodiment (not illustrated) of the present disclosure consists in that at least one of the codings 6 is formed as a visually identifiable coding 6, in particular a colored labeling. The haptically perceptible coding 6 may expediently also be formed so as to additionally be visually perceptible.

The visually perceptible coding 6 may expediently be formed such that it discloses the checking setting of the bearing sleeve 1, and/or the coding angle, to the user.

A combination of a haptically perceptible coding 6 and a visual, in particular colored, coding 6 may particularly advantageously be provided. For example, the first coding 6 for detecting the checking setting of the bearing sleeve 1 may be formed as a haptically perceptible coding 6, whilst the second coding 6, formed as a key marking, for determining the coding angle is formed as a visually perceptible coding 6. The first coding 6 is advantageously provided by means of a position of the haptically perceptible coding 6 on the bearing sleeve 1. The visually perceptible coding 6 may expediently be arranged or formed on the bearing sleeve 1 independently of the first, in particular haptically perceptible coding 6.

In one particular embodiment, the first and the second coding 6 are provided by virtue of a color being applied to the haptically perceptible coding 6. Here, the checking setting of the bearing sleeve 1 can be detected from the position of the haptically perceptible coding 6, and the coding angle can be detected from the color.

With reference in particular to the exemplary embodiment illustrated in FIGS. 3, 16, 18 and 20, it can be seen that the coding 6 of the bearing sleeve 1 is arranged in alignment with the blocking device 10, as is expediently also illustrated in FIGS. 4 and 5. In this exemplary embodiment, the release portion 22 running axially with respect to the actuating shaft 18 is advantageously situated on the side pointing away from the aperture 2. In particular, the bearing sleeve 1 is situated in its checking setting when the coding 6 points toward the aperture 2, such that said coding can be detected, in particular by means of the checking tool 8. Since the blocking device 10 and the coding 6 are in alignment with one another, it is necessary, in order to transfer the bearing sleeve 1 into its release position, for the bearing sleeve to be rotationally adjusted about the actuating shaft 18 until the blocking device 10 reaches the release portion 22 formed on the opposite side, or the intersection of the release portion and the blocking portion. For the bearing sleeve 1 illustrated in FIGS. 1, 4, 5, 16, 18 and 20, and based on the assembly illustrated in FIGS. 1 to 3 and 15 to 20, this expediently yields a checking angle of 180°.

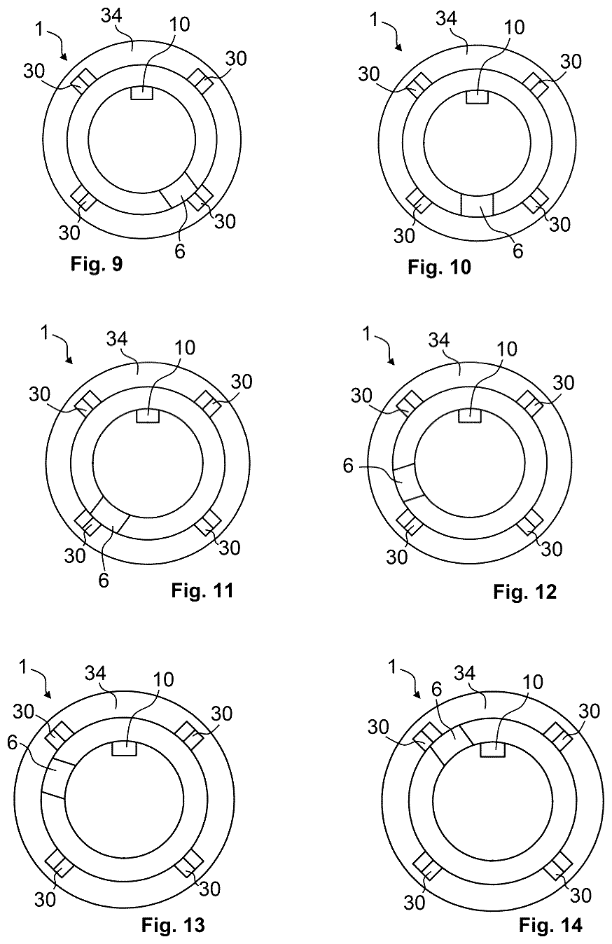

The checking angles of the bearing sleeves 1 illustrated in FIGS. 6 to 14, based on the assembly illustrated in FIGS. 1 to 3 and 15 to 20, are listed by way of example below, wherein the checking angles are dependent on the direction of rotation, that is to say dependent on a rotation of the bearing sleeve 1, clockwise or counterclockwise: Expediently,
the checking angle in the embodiment of the bearing sleeve 1 illustrated in FIG. 6 is 216° or 144°, depending on the direction of rotation,
the checking angle in the embodiment of the bearing sleeve 1 illustrated in FIG. 7 is 252° or 108°, depending on the direction of rotation,
the checking angle in the embodiment of the bearing sleeve 1 illustrated in FIG. 8 is 288° or 72°, depending on the direction of rotation,
the checking angle in the embodiment of the bearing sleeve 1 illustrated in FIG. 9 is 324° or 36°, depending on the direction of rotation,
the checking angle in the embodiment of the bearing sleeve 1 illustrated in FIG. 10 is 360° or 0°, irrespective of the direction of rotation,
the checking angle in the embodiment of the bearing sleeve 1 illustrated in FIG. 11 is 36° or 324°, depending on the direction of rotation,
the checking angle in the embodiment of the bearing sleeve 1 illustrated in FIG. 12 is 72° or 288°, depending on the direction of rotation,
the checking angle in the embodiment of the bearing sleeve 1 illustrated in FIG. 13 is 108° or 252°, depending on the direction of rotation,
the checking angle in the embodiment of the bearing sleeve 1 illustrated in FIG. 14 is 144° or 216°, depending on the direction of rotation.

In particular, as illustrated in FIG. 1, the coding wheels 12 can be pushed with an inner bearing opening 26 axially onto the respective bearing sleeves 1. To transmit a rotation of the coding wheels 12 to the bearing sleeve 1, it has proven to be advantageous for the coding wheels 12 to have an inwardly pointing toothing 28 which engages into a holding geometry 30 on an outer circumference of the bearing sleeves 1 such that the rotation of the particular coding wheel 12 can be transmitted at least in one direction of rotation to the bearing sleeve 1.

To improve the arrangement of the coding wheels 12 on the bearing sleeves 1, the bearing sleeves 1 may be provided so as to have a bearing portion 32 and an abutment portion 34 of enlarged diameter, which abutment portion is preferably formed as a collar, as illustrated in FIG. 4. The abutment portion 34 has the advantage that, as the particular coding wheel 12 is pushed axially onto the associated bearing sleeve 1, the coding wheel 12 cannot be pushed beyond the bearing sleeve 1, and instead abuts against the abutment portion 34 as an end stop. It may expediently also be the case that the holding geometries 30 project axially out of the abutment portion 34, wherein the holding geometries 30 preferably extend over a part of the bearing portion 32, as illustrated in FIG. 4. In an alternative embodiment that is not illustrated, the holding geometries 30 extend over the entire axial extent of the bearing portion 32 of the bearing sleeve 1 proceeding from the abutment portion 34.

In particular, the bearing sleeves 1 are of single-piece, in particular monolithic single-piece form.

One specific variant of the invention provides for the coding wheels 12 to be movable relative to the respective bearing sleeves 1 axially between a normal setting, in which the coding wheel 12 is fastened rotationally conjointly to the bearing sleeve 1, and a configuration setting. In this embodiment, it is expediently the case that, in the configuration setting, the coding wheel 12 is freely rotatable relative to the associated bearing sleeve 1 and can be re-installed into the normal setting with an angular offset on the bearing sleeve 1.

In particular, the coding wheel 12 and the bearing sleeve 1 are rotationally adjusted in stepped fashion. By way of example, the coding wheel 12 illustrated in particular in FIG. 3 has ten steps, each step having an angular offset of 36° with respect to the preceding step. The variants of the bearing sleeves 1 illustrated in FIGS. 5 to 14 are expediently all combinable with the locking mechanism illustrated in FIG. 1, or the bearing sleeves 1 are designed to be interchangeable with one another. Accordingly, FIGS. 5 to 14 illustrate all of the possible checking angles for a coding wheel 12, or bearing sleeve 1, which is adjustable in ten steps.

In particular, a stepped rotational adjustment of the coding wheel 12 or of the bearing sleeve 1 can be provided by means of a detent geometry 36 formed on an outer lateral surface. In particular, in the exemplary embodiment illustrated in FIG. 1, indentations running axially over the lateral surface of the coding wheel 12 are formed, as detent geometries 36, such that a correspondingly designed detent element (not illustrated), in particular an elastic detent arm, engages with detent action into each of the indentations during the rotational adjustment of the coding wheel 12. The detent arm expediently fixes the coding wheel 12 in the particular step, wherein the fixing can be overcome by way of a sufficiently high torque.

FIG. 21 illustrates an alternative variant of the bearing sleeve 1a. Said bearing sleeve, similarly to the bearing sleeve 1 illustrated in FIG. 4, has a bearing portion 32 for the arrangement of a coding wheel 12 and has an abutment portion 34 for axially blocking a movement of the coding wheel 12. By contrast to the bearing sleeve 1 in FIG. 4, however, the bearing sleeve 1a in FIG. 21 does not have a radially inwardly pointing lug as a blocking device 10. In the bearing sleeve 1 illustrated in FIG. 21, the blocking device 10 is provided by the abutment portion 34 of enlarged diameter, in particular the collar, wherein the abutment portion 34 has a cutaway portion 38 at at least one point on its circumference, as illustrated in FIG. 21.

The bearing sleeve 1 illustrated in FIG. 21 is used in particular in combination with a locking bolt guided parallel to the actuating shaft 18, which locking bolt, when all of the bearing sleeves 1 are in the release setting, is movable axially into a release position, in which the locking mechanism is in the opening position and unlocked, and when at least one bearing sleeve 1 is in the blocking setting, said actuating shaft is blocked, by means of the blocking device 10 in the form of the abutment portion 34, in a locking position in which the locking mechanism is locked in the blockage position.

The locking bolt expediently has abutment elements designed correspondingly to the abutment portions 34, with in each case one abutment element being formed for each bearing sleeve 1 or for each abutment portion 34. In particular, when the bearing sleeve 1 is in the blocking setting, the associated abutment element of the locking bolt abuts axially against the abutment portion 34 formed as the blocking device 10, in such a way that an axial movement of the locking bolt is blocked in form-fitting fashion. The cutaway portion 38 in the abutment portion 34 of the bearing sleeve 1 illustrated in FIG. 21, and the associated abutment element, are expediently designed correspondingly to one another such that, when the bearing sleeve 1 is in the release setting, the abutment element is not in axially abutting contact with the abutment portion 34 of the bearing sleeve 1. In particular, it is thus ensured that, when all of the bearing sleeves 1 are arranged in their respective release settings, the locking bolt can be transferred axially into its release position, wherein the abutment elements of the locking bolt can be passed through underneath the respective cutaway portions 38.

The invention is not limited to the exemplary embodiments illustrated and described; rather, it also encompasses all equivalent embodiments within the meaning of the present disclosure. It is expressly pointed out that the exemplary embodiments are not limited to all of the features in combination; rather, each individual sub-feature, even considered separately from all other sub-features, can be of independently inventive significance. Furthermore, the invention is also not limited to any specific combination of features defined herein, but may also be defined by any other combination of particular features from among all of the individual features disclosed. This means that, in principle, practically any individual feature may be omitted or substituted by at least one individual feature disclosed elsewhere in the application.

1. A combination lock, in particular a suitcase lock, comprising a locking mechanism through which the combination lock can be transferred from a blockage position into an opening position, the locking mechanism including at least three rotationally adjustable bearing sleeves,
wherein the locking mechanism is, by at least one bearing sleeve being in a blocking setting of the bearing sleeve, blocked by a blocking device of the bearing sleeve so as to be prevented from being transferred from the blockage position into the opening position, and, by virtue of all of the bearing sleeves being arranged in a release setting of each bearing sleeve, said locking mechanism is released for a movement from the blockage position into the opening position,
wherein, on each bearing sleeve, there is arranged a coding wheel which projects partially into an aperture in a front cover, such that a checking setting of each of the bearing sleeves can be detected through the aperture on the basis of a coding, which is perceptible from the outside, of the bearing sleeve, and the release setting of the bearing sleeve can be set by virtue of the bearing sleeve being rotated through a coding angle of the particular bearing sleeve proceeding from the checking setting of the bearing sleeve,
wherein the coding angles of at least two bearing sleeves differ, and the bearing sleeves have a second coding which is formed as a key marking such that the coding angle of the particular bearing sleeve is fixedly assigned to the form of the key marking and can thus be determined, and the second coding, formed as a key marking, is formed as an all-over coloration of the bearing sleeve or of the material of the bearing sleeve or is haptically perceptible by means of a checking tool.

2. The combination lock according to claim 1, wherein at least one of the codings is formed as a visually identifiable coding.

3. The combination lock according to claim 1, wherein the haptically perceptible second coding is formed as a notch formed in the bearing sleeve, the notch having a width which is determinable as a key marking by means of the checking tool,
wherein the width indicates the coding angle.

4. The combination lock according to claim 1, wherein the coding, by means of which the checking setting of the bearing sleeve can be detected, is provided by means of a position of the haptically perceptible coding on the bearing sleeve, and the second coding, which is formed as a key marking and by which the coding angle can be determined, is provided in a form of the haptically perceptible coding.

5. The combination lock according to claim 1, wherein the locking mechanism has an actuating shaft, and the bearing sleeves having the coding wheels are arranged on the actuating shaft so as to be mutually independently rotatable and so as to be coaxial with respect to one another, wherein, when all of the bearing sleeves are in the release setting, the actuating shaft is movable axially into a release position, in which the locking mechanism is in the opening position and unlocked, and when at least one bearing sleeve is in the blocking setting, said actuating shaft is blocked, by means of the blocking device, in a locking position in which the locking mechanism is locked in the blockage position.

6. The combination lock according to claim 1, wherein the bearing sleeves having the coding wheels are arranged in planar fashion with respect to one another, and so as to be mutually independently rotatable, on respectively dedicated actuating shafts, wherein the actuating shafts run parallel to one another and are offset with respect to one another.

7. The combination lock according to claim 1, wherein the coding wheels are movable relative to the respective bearing sleeves axially between a normal setting, in which the coding wheel is fastened rotationally conjointly to the bearing sleeve, and a configuration setting such that, in the configuration setting, the coding wheel is freely rotatable relative to the associated bearing sleeve and can be re-installed into the normal setting with an angular offset on the bearing sleeve.

8. The combination lock according to claim 1, wherein the coding angles are paired with the serial number of the particular combination lock or with a serial number of a suitcase in which the combination lock is installed, such that, based on the serial number, the associated coding angles can be retrieved from a database.

9. The combination lock according to claim 1, wherein the coding angle is applied, as an alphanumeric code in encrypted form and so as to be identifiable from the outside, to the combination lock or to a suitcase in which the particular combination lock is installed.

10. The combination lock according to claim 1, wherein the coding angles are stored in an RFID tag and can be read out by means of a corresponding RFID reader.

11. A suitcase, in particular for luggage, having a receiving space which can be closed by a combination lock according to claim 1.

12. The suitcase according to claim 11, wherein the receiving space can be closed by the combination lock, wherein at least one of the codings is formed as a visually identifiable coding.

13. The combination lock according to claim 2, wherein the visually identifiable coding is a colored label.

14. The combination lock according to claim 10, wherein the RFID tag is formed on the combination lock itself or on the suitcase in which the particular combination lock is installed.

15. The suitcase according to claim 11, wherein the receiving space can be closed by the combination lock, wherein the haptically perceptible second coding is formed as a notch formed in the bearing sleeve, the notch having a width which is determinable as a key marking by means of the checking tool,
wherein the width indicates the coding angle.

16. The suitcase according to claim 11, wherein the receiving space can be closed by the combination lock, wherein the coding, by means of which the checking setting of the bearing sleeve can be detected, is provided by means of a position of the haptically perceptible coding on the bearing sleeve, and the second coding, which is formed as a key marking and by which the coding angle can be determined, is provided in a form of the haptically perceptible coding.

17. The suitcase according to claim 11, wherein the receiving space can be closed by the combination lock, wherein the locking mechanism has an actuating shaft, and the bearing sleeves having the coding wheels are arranged on the actuating shaft so as to be mutually independently rotatable and so as to be coaxial with respect to one another, wherein, when all of the bearing sleeves are in the release setting, the actuating shaft is movable axially into a release position, in which the locking mechanism is in the opening position and unlocked, and when at least one bearing sleeve is in the blocking setting, said actuating shaft is blocked, by means of the blocking device, in a locking position in which the locking mechanism is locked in the blockage position.

18. The suitcase according to claim 11, wherein the receiving space can be closed by the combination lock, wherein the bearing sleeves having the coding wheels are arranged in planar fashion with respect to one another, and so as to be mutually independently rotatable, on respectively dedicated actuating shafts, wherein the actuating shafts run parallel to one another and are offset with respect to one another.

19. The suitcase according to claim 11, wherein the receiving space can be closed by the combination lock, wherein the coding wheels are movable relative to the respective bearing sleeves axially between a normal setting, in which the coding wheel is fastened rotationally conjointly to the bearing sleeve, and a configuration setting such that, in the configuration setting, the coding wheel is freely rotatable relative to the associated bearing sleeve and can be re-installed into the normal setting with an angular offset on the bearing sleeve.

20. The suitcase according to claim 11, wherein the receiving space can be closed by the combination lock;
wherein the coding angles are paired with the serial number of the particular combination lock or with a serial number of a suitcase in which the combination lock is installed, such that, based on the serial number, the associated coding angles can be retrieved from a database; or
wherein the coding angle is applied, as an alphanumeric code in encrypted form and so as to be identifiable from the outside, to the combination lock or to a suitcase in which the particular combination lock is installed; or
wherein the coding angles are stored in an RFID tag and can be read out by means of a corresponding RFID reader.
